(19) United States
(12) Patent Application Publication
(10) Pub. No.: US 2008/0295542 A1
(43) Pub. Date: Dec. 4, 2008

(54) Method for Marking Single Pane Security

(76) Inventors: Thomas Rainer, Halle/Saale (DE); Reinhard Borek, Halle (DE)

Correspondence Address: K.F. ROSS P.C., 5683 RIVERDALE AVENUE, SUITE 203 BOX 900, BRONX, NY, 10471-0900, US

(21) Appl. No.: 12/095,755

(22) PCT Filed: Dec. 1, 2006
(86) PCT No.: PCT/EP2006/011550

§ 371 Date: Jun. 2, 2008

(30) Foreign Application Priority Data
Dec. 2, 2005 (DE) 10 2005 057 916.7

(51) Int. Cl. C03C 25/46

(52) U.S. Cl. 65/446

(57) ABSTRACT

The invention relates to a method for marking single pane security glass, produced from single pane glass by a heat treatment said single pane glass (1) being provided with at least one metal-particle- or metal-ion- containing marking, generated by laser irradiation (3) of a metal ion donor material (2) arranged on the single pane glass, said single pane glass (1) being subjected to a heat treatment to form single pane security glass (1) wherein at least one marking is altered by the heat treatment and it may be checked whether a change to at least one marking has occurred and thus the heat treatment may be verified.

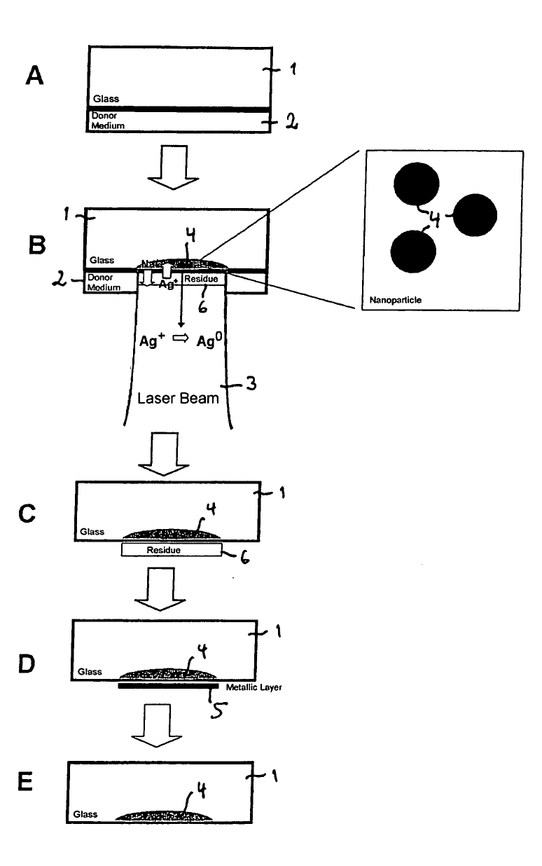

The invention concerns a method of marking of single pane safety glass, which is made from single pane glass by a heat treatment.

Such methods for fabrication of single pane safety glass are rather well known in the prior art. For this, a single pane glass, fabricated to the desired dimensions, is subjected to a particular heat treatment to form single pane safety glass, which upon shattering breaks down into many small blunt-edged glass fragments, instead of large sharp-edged pieces. Such glass is used, for example, in the side windows of motor vehicles, and also usually for overhead glazing work.

The heat treatment is usually such that the single pane glass is heated up to a certain temperature level for a certain length of time and then cooled down relatively fast, in order to “freeze” the resulting stresses in the glass.

It is known how to mark single pane safety glass as such after its fabrication, so that one can still tell afterwards whether a pane of glass is normal glass or a single pane safety glass.

It should be noted that single pane safety glass with the appropriate safety-relevant quality is only formed when the heat treatment complies with predetermined criteria, such as a particular length and particular temperature level. However, the maintaining of such conditions cannot be identified from a marking known in the prior art, which is usually affixed afterwards.

The problem of the invention is therefore to provide a process with which a marking of single pane safety glass is created, from which it is immediately identifiable that the glass has gone through the necessary heat treatment for the production of single pane safety glass and, in particular, that the necessary boundary conditions for this have been observed.

This problem is solved according to the invention in that a single pane glass is first provided prior to a heat treatment with at least one marking containing metal particles and/or metal ions, which is generated by laser irradiation of a metal ion donor medium arranged on the single pane glass.

In a further process step, the single pane glass is then subjected to a heat treatment to form single pane safety glass, whereupon at least one marking is altered by the heat treatment. This makes it possible to ascertain whether a change and in particular a desired or anticipated change in at least one marking has taken place, so as to verify the performing of the heat treatment and especially its correct performance, i.e., the observance of predetermined parameters such as duration and temperature level.

In an especially preferred embodiment of the invented method, it can be provided that a marking is generated prior to the heat treatment by a diffusing of metal ions from the donor medium into the glass by virtue of the heat brought in by the laser light and a reduction of the metal ions in the glass to form metal particles. In this case, in particular by variation of the laser light, for example, the intensity, focus size, duration, etc., the intensity of the diffusion of the metal ions into the glass and also the intensity of the reduction and possibly the intensity of a particle growth are influenced. Such a marking is furthermore characterized in that it is arranged in the volume of the glass and hence cannot be manipulated in any way from the outside.

According to another embodiment of the invented method, it can be provided that a marking is created prior to the heat treatment by a reducing of the metal ions of the donor medium in the surrounding atmosphere and a depositing of the thus created metal particles onto the surface of the single pane glass.

In particular, this process step can take place at the same time as the above-described process step, with appropriate choice of the laser irradiation parameters, as above-described. Thus, one can produce a twofold marking of the glass in one and the same process step, namely, on the one hand in the volume by the above described diffusion of metal ions and on the other hand by depositing of elemental metal onto the surface.

The two possible types of marking can undergo different changes in the further course of the treatment of the single pane glass, i.e., especially the heat treatment, in order to form single pane safety glass, so that a verification of the heat treatment can also take place by means of these two markings, independently or in combination.

According to another preferred process step, it can be provided that a marking is produced prior to the heat treatment by a depositing of combustion residue of the donor medium or a material carrying the donor medium by virtue of the laser light. Thus, for example, by irradiating the donor medium or the material carrying the donor medium with the laser light, in addition to the above-described process steps of diffusion and possibly deposition of elemental metal, at the same time one can bring about a combustion of the donor medium or the material carrying this donor medium by appropriate design of the laser irradiation, so that corresponding combustion deposits can be formed on the surface of the single pane glass.

Here one can preferably provide that all three above-described markings are created at the same time in one and the same process step, namely, the irradiation of the single pane glass with laser light on a donor medium.

As regards the first two mentioned markings, i.e., by diffusion of ions on the one hand and by deposition of elemental metal on the other hand, it should be noted that these involve markings which have only relatively slight contrast to the surrounding transparent glass material and thus can only be read with difficulty, especially if a machine readability by an appropriately provided device is desired.

In this regard, the third kind of marking by combustion residue is especially advantageous, since this produces a very high-contrast surface marking of the same content as the two above-described markings, which is usually easier to read because of its high contrast, especially by means of machine reading devices.

According to another embodiment of the invented method, it can thus be provided to read at least one of the three above-described markings prior to a heat treatment for the formation of the single pane safety glass, giving special preference here to the marking with combustion residue, on account of the ease of reading.

Thus, a reference can be produced by the reading, especially of the last mentioned marking, and this can be used at a later time for purposes of a comparison.

According to the method of the invention, the heat treatment for the production of single pane safety glass can have the effect that the color of the marking of metal particles and/or metal ions located in the volume of the single pane glass or after the heat treatment of the single pane safety glass is altered. For example, the alteration of the color of this marking can be dependent on the duration and/or the temperature of the heat treatment. For example, it can be provided to work with silver ions, or with silver particles after diffusion and reduction, for the marking in the volume of the glass. Such a marking is usually brownish in color, often also known as sepia, with no further heat treatment.

After the heat treatment, however, such a marking can take on different colors, and the colorations as already mentioned can be dependent on the duration and the temperature reached. Therefore, the option exists of using the resulting color change to make inferences as to whether the heat treatment for production of single pane safety glass was carried out and also, perhaps, whether it was done properly, i.e., with the right parameters of duration and temperature.

In order to transport silver ions into the glass medium by means of the above-described process step of laser irradiation, it can be provided to use a donor medium containing silver ions. For example, this can be a support foil carrying such a donor medium. Basically, however, it can be provided in the context of the invention to use any given donor medium containing metal ions, and the original colors prior to the heat treatment and the color changes occurring after the heat treatment will depend in particular on the type of metal ions, and thus in particular the kind of metal.

According to the method of the invention, it can also be provided that a surface marking is removed by a heat treatment, especially the pure metal deposition. This can be accomplished, for example, in that the elemental metallic deposits on the surface diffuse into the glass material or are burned away by the heat treatment, for example, by oxidation effects. Thus, the fact that the pure metal elemental deposit is no longer present on the surface of the glass after a heat treatment constitutes evidence that the heat treatment was carried out, on the one hand, and also that it was done with the right parameters, on the other hand. Thus, in particular, the choice of the parameters of the laser irradiation can be selected so that the pure metallic surface marking is only totally dissolved during the heat treatment if the duration and temperature level are observed. This can be achieved, in particular, by the intensity or thickness of the surface marking when producing the laser irradiation. Thus, for an appropriately chosen thickness, too low a temperature level or too short a duration of the heat treatment are not sufficient to remove the pure metal deposit, so that its presence after the heat treatment indicates that it was not sufficient.

Thus, in the context of the invention, there are already two possible criteria for checking the performance of the heat treatment, on the one hand, and the observance of the necessary parameters, on the other. If need be, the surface marking by combustion residue can also be used in the context of the method, since this combustion residue can also be removed by the heat treatment, for example. If need be, it can likewise be provided to remove this combustion residue prior to the heat treatment by a cleaning process, such as a washing process, especially to avoid a covering of the pure metallic surface marking by the combustion residue during the heat treatment.

In order to enable further influencing of whether combustion residue can even arise, or how intensely this will occur, the donor medium and/or a carrier of the donor medium can be chosen such that this donor medium or the carrier has its maximum absorption at the laser wavelength used. This can be accomplished, e.g., by a coloration. For example, if a green laser is being used, such as a frequency-doubled Nd:YAG laser, then preferably a donor medium or a carrier of the donor medium with red coloration is chosen for maximum absorption. This will make sure that donor medium or carrier will burn in suitable manner during the laser irradiation and leave behind an appropriate surface marking, which can at least be read in simple fashion by machine prior to the heat treatment.

In the context of the present invention it can be provided that a checking of the markings is done automatically after a heat treatment to produce single pane safety glass. For this, one can again use automatic machine reading devices. Thus, the performance and the observance of the needed parameters of heat treatment can be verified directly in the manufacturing process. If need be, it can also be provided to perform an inspection of the glass afterwards, only when complaints are made.

Thus, for example, it can be provided to compare at least one marking read after the heat treatment with at least one marking made prior to the heat treatment. Different reading methods can be used for this, as need be.

Markings of different kind can also be used for this comparison, depending on the above-described three types. This shall be illustrated by an example.

For example, prior to the heat treatment the marking can be read by combustion residue, whereas after the heat treatment this combustion residue might no longer be present on account of the heat treatment, for example. Accordingly, if the same reading method is used, no such marking will be found when reading this marking after the heat treatment.

One can proceed likewise with the pure metallic surface marking. For example, if a reading method is used to read this pure metallic surface marking, this marking might no longer be detected after a properly performed heat treatment.

Furthermore, it can be provided to check whether the marking in the interior of the glass has undergone the desired or expected discoloration on account of the diffusion of ions by means of a special reading method attuned to the expected discoloration of the volume marking. Thus, an inference can also be drawn from this that the heat treatment was performed with the correct parameters.

On the basis of a reading of information in a marking prior to the heat treatment, e.g., the elemental surface metal or the combustion residue, one knows which information the treated pane should contain in the marking. After the heat treatment, one can then try to read, for example, only the marking in the volume of the glass, which is only possible with a suitable reading method if the anticipated discoloration has taken place. Thus, if the information initially read is also read after the heat treatment with the different method, the treatment has taken place correctly.

Since the marking is low contrast, especially for the marking in the volume of the glass, it can be provided to use a reading method during the reading of this marking whereby the glass is illuminated with UV light at the same time. In this way, one can heighten the contrast between the marking and the transparent surroundings of the marking in the glass.

First, on the one hand, because the glass surroundings of the marking are excited into fluorescence, for example, while the marking itself does not fluoresce. On the other hand, an illumination with UV light at first creates fluorescent light in the glass pane, which is propagated by total reflection between the pane surfaces and illuminates the marking, so that thanks to changes in the index of refraction at the marking the fluorescent light exits and thus the marking appears bright and is therefore easier for a machine to read.

Thus, the above-described method of the invention, in summary, offers two or if necessary three types of markings, which can all be produced by means of one and the same process step of laser illumination thanks to a donor medium, while a change in these markings, at least one of these markings during a heat treatment process for the making of single pane safety glass, allows inferences as to whether the heat treatment was carried out and whether its parameters were observed. Thus, the method of the invention offers a simple and economical option of producing a marking for single pane safety glass and thus of inspecting the single pane safety glass.

The following FIGURE illustrates the possible steps of the process.

It can be seen that in step A the surface of a glass pane 1 is provided with a donor medium 2 for silver ions, at least in the region of the glass pane 1 where a marking is supposed to be arranged. This donor medium 2 can be arranged, e.g., on a carrier foil, not shown here. In this way, the glass pane 1 is prepared to receive a marking.

In step B, by means of a focused laser beam 3, the glass pane 1 is illuminated through the donor medium 2, in which case the laser beam 3 can be operated in pulses or continuously and it follows a trajectory so as to write a marking. Thanks to the heat brought in, an exchange of sodium and silver ions takes place, with the silver ions diffusing into the glass of the glass pane 1 and building up there near the surface and at least some of them are reduced to silver particles 4. At the same time, a pure metallic silver layer 5 is deposited on the surface of the glass pane 2 [!], lying underneath the combustion residue 6 of the donor medium 2. This is shown by the drawing per step C. At the right side in step B is shown the cross section of an arrangement of silver nanoparticles 4 of a marking, which have been carried into the glass 1 by means of the laser beam 3.

The high-contrast marking by the combustion residue 6 can now be read, e.g., by machine, and then be removed by a washing process per step D, for example, so that the pure metallic silver layer 5 is identifiable, as shown by step D.

After step D, the heat treatment is carried out to produce single pane safety glass. In this process, on the one hand, the color of the accumulation 4 of silver ions and particles changes and, on the other hand, additional silver particles can diffuse into the glass surface from the pure silver layer 5.

This is depicted in step E, where the pure silver layer 5 has been removed on the basis of the heat treatment by diffusion into the glass volume and possibly by oxidation or other surface processes. Thanks to the changes in the near-surface volume region of the glass pane 1 and on the surface, the marking after the heat treatment can be clearly distinguished from a marking prior to the heat treatment, so that there is evidence of the performance of the heat treatment.

1. A method of marking of single pane safety glass, which is made from single pane glass by a heat treatment, characterized by the following process steps:
a single pane glass is first provided prior to a heat treatment with at least one marking containing metal particles and/or metal ions, which is generated by laser irradiation of a metal ion donor medium arranged on the single pane glass, wherein a marking is generated prior to the heat treatment by a diffusing of metal ions from the donor medium into the glass by virtue of the heat brought in by the laser light and a reduction of the metal ions in the glass to form metal particles
the single pane glass is subjected to a heat treatment to form single pane safety glass, whereupon at least one marking is altered by the heat treatment
so that one can check whether a change is present in at least one marking and verify that the heat treatment has been performed.

2. The method per claim 1 wherein a marking is created prior to the heat treatment by a reducing of the metal ions of the donor medium in the surrounding atmosphere and a depositing of the thus created metal particles onto the surface of the single pane glass.

3. The method per claim 1 wherein a marking is produced prior to the heat treatment by a depositing of combustion residue of the donor medium or a material carrying the donor medium by virtue of the laser light.

4. The method per claim 1 wherein one marking is read prior to the heat treatment, especially to form a reference.

5. The method per claim 1 wherein the color of the marking of metal particles and/or metal ions located in the volume of the single pane safety glass is altered by a heat treatment.

6. The method per claim 1 wherein a surface marking is removed by a heat treatment, especially the pure metal deposition.

7. The method per claim 1 wherein the change, especially a color change, is dependent on the duration and/or the temperature of the heat treatment.

8. The method per claim 1 wherein a donor medium containing silver ions is used.

9. The method per claim 1 wherein the donor medium and/or a carrier of the donor medium has its maximum absorption at the laser wavelength used, especially due to coloration, in order to bring about a combustion upon laser irradiation.

10. The method per claim 1 wherein a checking of at least one marking is done after a heat treatment, especially automatically by means of a reading device provided for this.

11. The method per claim 1 wherein a marking read after the heat treatment is compared with a marking made prior to the heat treatment, especially by reading with different reading methods.
